(19) United States
(12) Patent Application Publication
(10) Pub. No.: US 2026/0214595 A1
(43) Pub. Date: Jul. 23, 2026

(54) METHOD AND DEVICE FOR REPORTING POWER INFORMATION, AND STORAGE MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 19/144,623

(22) PCT Filed: Dec. 30, 2022
(86) PCT No.: PCT/CN2022/144337

§ 371 Date: Jun. 30, 2025

(51) Int. Cl. H04W 52/36

(52) U.S. Cl. CPC H04W 52/365; H04W 52/367

(57) ABSTRACT

The present disclosure provides a method and a device for reporting power information. The method includes: determining power field enhancement information of one or more carriers/cells based on an SAR or MPE requirement, wherein the power field enhancement information includes one or more of Power Headroom, Maximum Power Reduction, and transmit power information; and reporting the power field enhancement information of the one or more carriers/cells to a network device.

### CROSS-REFERENCE TO RELATED APPLICATIONS

The present disclosure is the U.S. National Phase application of International Application No. PCT/CN2022/144337 filed on Dec. 30, 2022, the content of which is incorporated herein by reference in its entirety for all purposes.

### TECHNICAL FIELD

The present disclosure relates to the field of communication technology, in particular, to a method for reporting power information, an apparatus for reporting power information, and a storage medium.

### BACKGROUND

In New Radio (NR) technology, a terminal equipped with dual power amplifiers (PA) supports both Carrier Aggregation (CA) and Dual Connection (DC). In these scenarios, the terminal can send uplink physical channels or reference signals simultaneously on multiple carriers.

### SUMMARY

According to a first aspect, the present disclosure provides a method for reporting power information, performed by a terminal, the method including: determining power field enhancement information of one or more carriers/cells, wherein the power field enhancement information is based on Specific Absorption Rate (SAR) or Maximum Permissible Exposure (MPE) requirements, and includes one or more of Power Headroom, Maximum Power Reduction, and transmit power information; and reporting the power field enhancement information of the one or more carriers/cells to a network device.

According to a second aspect, the present disclosure provides a method for reporting power information, performed by a network device, the method including: receiving power field enhancement information of one or more carriers/cells sent by a terminal, wherein the power field enhancement information is based on Specific Absorption Rate (SAR) or Maximum Permissible Exposure (MPE) requirements, and includes one or more of Power Headroom, Maximum Power Reduction, and transmit power information.

According to a third aspect, the present disclosure provides a device for reporting power information, including: a processor; and a memory configured to store executable instructions for the processor; wherein the processor is configured to perform the method for reporting power information as described in the first aspect and any embodiments of the first aspect.

According to a fourth aspect, the present disclosure provides a device for reporting power information, including: a processor; and a memory configured to store executable instructions for the processor; wherein the processor is configured to perform the method for reporting power information as described in the second aspect and any embodiments of the second aspect.

According to a fifth aspect, the present disclosure provides a non-transitory computer-readable storage medium having instructions stored thereon, which when executed by a processor of a terminal, cause the terminal to perform the method for reporting power information as described in the first aspect and any embodiments of the first aspect.

According to a sixth aspect, the present disclosure provides a non-transitory computer-readable storage medium having instructions stored thereon, which when executed by a processor of a network device, cause the network device to perform the method for reporting power information as described in the second aspect and any embodiments of the second aspect.

It should be understood that the general description above and the detailed description in the following are only illustrative and explanatory, and do not limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure.

FIG. 1 is a schematic diagram of a wireless communication system according to one or more embodiments.

FIG. 2 is a schematic diagram of cumulative transmit power control for a terminal according to one or more embodiments.

FIG. 3 is a schematic diagram of a power arrangement according to one or more embodiments.

FIG. 4 is a schematic diagram of a power arrangement according to one or more embodiments.

FIG. 5 is a schematic diagram of a power arrangement according to one or more embodiments.

FIG. 6 is a diagram of a single-carrier PHR configuration format according to one or more embodiments.

FIG. 7 is a diagram of a multi-carrier PHR configuration format according to one or more embodiments.

FIG. 8 is a flowchart of a method for reporting power information according to one or more embodiments.

FIG. 9 is a flowchart of a method for reporting transmit power information according to one or more embodiments.

FIG. 10 is a flowchart of a method for reporting transmit power information according to one or more embodiments.

FIG. 11 is a flowchart of a method for reporting a power class type according to one or more embodiments.

FIG. 12 is a flowchart of a method for reporting power information according to one or more embodiments.

FIG. 13 is a flowchart of a method for reporting transmit power information according to one or more embodiments.

FIG. 14 is a flowchart of a method for reporting transmit power information according to one or more embodiments.

FIG. 15 is a flowchart of a method for reporting a power class type according to one or more embodiments.

FIG. 16 is a block diagram of an apparatus for reporting power information according to one or more embodiments.

FIG. 17 is a block diagram of an apparatus for reporting power information according to one or more embodiments.

FIG. 18 is a block diagram of a device for reporting power information according to one or more embodiments.

FIG. 19 is a block diagram of a device for reporting power information according to one or more embodiments.

### DETAILED DESCRIPTION

A detailed explanation of exemplary embodiments, examples of which are illustrated in the drawings, will be provided herein. When the following description involves drawings, unless otherwise indicated, the same numerals in different drawings represent the same or similar elements. The examples described in the following embodiments do not represent all embodiments consistent with the present disclosure.

As described in the background, in New Radio (NR) technology, a terminal equipped with dual power amplifiers (PA) supports both Carrier Aggregation (CA) and Dual Connection (DC). In these scenarios, the terminal can send uplink physical channels or reference signals simultaneously on multiple carriers.

In uplink CA and DC, a maximum transmit power of the terminal on a band combination (BC) is limited by the terminal power class defined for BC. The terminal with a higher power (high power user equipment, HPUE) is supported in the related art, to better utilize the independent PA of the terminal to achieve higher transmit power.

However, during the actual uplink transmission by the terminal, the actual transmit powers under different frequency ranges will be limited due to the requirements of Specific Absorption Rate (SAR) and Maximum Permissible Exposure (MPE), and the transmit power adjustment based on SAR and MPE requirements will also cause significant fluctuations or interruptions in the transmit power. Whether these power limits, power adjustments, and the HPUE can achieve the high-power transmission would greatly affect the scheduling by the network device.

If a network device can obtain power information related to a terminal and understand corresponding behaviors of the terminal, better scheduling decisions from the network device can be supported. Therefore, how to achieve the power information reporting and the corresponding mechanism and signaling is a problem that needs to be solved.

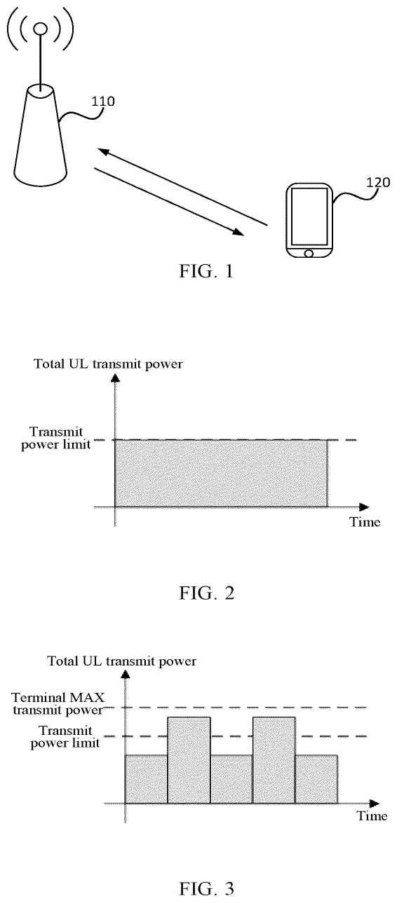

The method for reporting power information provided by the present disclosure can be applied to a wireless communication system shown in FIG. 1. The network system can include a network device 110 and a terminal 120. It can be understood that the wireless communication system shown in FIG. 1 is only for illustrative purposes. The wireless communication system can also include other network devices, for example, a core network device, a wireless relay device, a wireless backhaul device, etc., which are not shown in FIG. 1. The number of network devices and terminals included in the wireless communication system is not limited in embodiments of the present disclosure.

It can be further understood that the wireless communication system in embodiments of the present disclosure is a network that provides wireless communication functions. Wireless communication systems can adopt different communication technologies, such as code division multiple access (CDMA), wideband code division multiple access (WCDMA), time division multiple access (TDMA), frequency division multiple access (FDMA), orthogonal frequency division multiple access (OFDMA), single carrier FDMA (SC-FDMA), and carrier sense multiple access with collision avoidance. Networks can be divided according to factors such as different capacities, rates, and latencies, into 2G (generation) network, 3G network, 4G network, or a future evolved network, such as the 5th Generation (5G) Wireless Communication Network. The 5G network can also be referred to as New Radio (NR). For the convenience of description, the wireless communication network is sometimes referred to as a network in the present disclosure.

Further, the network device 110 involved in the present disclosure can also be referred to as a wireless access network device. The wireless access network device can be a base station, an evolved node B, a home base station, an access point (AP) in wireless fidelity (WIFI) system, a wireless relay node, a wireless backhaul node, a transmission point (TP) or a transmission and reception point (TRP), etc. The wireless access network device can also be gNB in NR system. Alternatively, the wireless access network device can be a component or a part of devices that constitute the base station. When used as a communication system in an Internet of vehicles (V2X), the network device can also be an onboard device. It should be understood that specific technologies and forms adopted by the network device are not limited in embodiments of the present disclosure.

Further, the terminal 120 involved in the present disclosure can also be referred to as a terminal device, user equipment (UE), a mobile station (MS), a mobile terminal (MT), etc., which are devices that provide voice and/or data connection to users. For example, the terminal can be a handheld device, a vehicle mounted device with wireless connection functions, etc. Some examples of terminals include smart mobile phones, pocket personal computers (PPCs), handheld computers, personal digital assistants (PDAs), laptops, tablets, wearable devices, or vehicle mounted devices. In addition, a communication system in an Internet of vehicles (V2X), the terminal device can also be an onboard device. It should be understood that specific technologies and forms adopted by the terminal are not limited in embodiments of the present disclosure.

In embodiments of the present disclosure, the network device 110 and the terminal 120 can use any feasible wireless communication technology to achieve the data transmission therebetween. In some embodiments, a transmission channel over which the network device 110 sends data or control information to the terminal 120 is referred to as a downlink (DL) channel, and a transmission channel over which the terminal 120 sends data or control information to the network device 110 is referred to as an uplink (UL) channel. It can be understood that the network device involved in embodiments of the present disclosure can be a base station. The network device can also be any other possible network devices, and the terminal can be any possible terminals, which are not limited in the present disclosure.

In New Radio (NR) technology, the terminal equipped with dual power amplifiers (PA) supports both Carrier Aggregation (CA) and Dual Connection (DC), and the maximum transmit power of the terminal will be affected by the power class (PC) defined by the terminal. Taking that the power class defined by the terminal is PC2 as an example, the PA capability of the terminal in different frequency bands can be different. For example, the terminal power configuration is shown in Table 1.

TABLE 1

| | Terminal | NR Carrier X | NR Carrier Y |
|---|---|---|---|
| | power class | power class | power class |
| Combination a | 26 dBm | 23 dBm | 23 dBm |
| Combination b | 26 dBm | 23 dBm | 26 dBm |
| Combination c | 26 dBm | 26 dBm | 23 dBm |
| Combination d | 26 dBm | 26 dBm | 26 dBm |

In some embodiments, Carrier X and Carrier Y represent different bands. As can be seen from Table 1, when the power class of the terminal in one frequency band is limited to 23 dBm, and the power class of the terminal in another frequency band is also limited to 23 dBm, the power class of the terminal will be limited to a maximum of 26 dBm. For the case of the combination b and combination c, when the power class of the terminal is limited to 23 dBm in one frequency band and 26 dBm in another frequency band, the power class of the terminal can only reach a maximum of 26 dBm due to specifications in relevant protocols. However, the actual value of the maximum transmit power of the terminal can reach 27.8 dBm under a terminal arrangement with independent PAs. For the case of the combination d, still due to the specifications in relevant protocols, the maximum transmit power of the terminal can only reach 26 dBm. However, the actual value of the maximum transmit power of the terminal can reach 29 dBm under the terminal arrangement with independent PAs. That is, the maximum transmit power of the terminal will be limited by the terminal power class specified in the protocol. In R17 regarding elevating the terminal power limit for CA/DC, for a frequency band combination where one frequency band supports a power class up to PC3 (23 dBm) while another frequency band supports a power class up to PC2 (26 dBm), it can be assumed that a total power associated with the frequency band combination is a sum of each power class.

In the related art, a new capability signaling, namely a maximum transmit power capability signaling, has been introduced for each frequency band combination. The signaling in R17 is mainly used for enhancement to the terminal in a CA scenario where the transmit power of the terminal supports power class PC3 in one frequency band and the transmit power of the terminal supports power class PC2 in another frequency band. In some embodiments, the frequency band can be a time division duplexing (TDD) frequency band or a frequency division duplexing (FDD) frequency band. The terminal can use two PAs to output a maximum composite power 27.8 dBm, based on the new maximum transmit power capability.

In the related art, the key to achieving simultaneous transmission across multiple frequency bands is for the terminal to comply with corresponding regulatory constraints when participating in the uplink transmission. The regulatory constraints on the total radio frequency (RF) exposure experienced by users require the terminal to determine a safe transmit power level, i.e. RF exposure level, for each frequency band. When the terminal approaches or exceeds the allowed RF exposure level, the terminal needs to recalculate the allowable maximum transmit power for each frequency band in use, and changes in the transmit power will also be caused in the uplink transmission. In some cases, the terminal can set a fixed limit on its transmit power, so that the transmit power of the terminal will never exceed the limit of the RF exposure level.

However, since the changes in the transmit power of the terminal are transparent to the network device, the network device is not aware of the reasons for the changes in the transmit power of the terminal, which can affect the sensing of the link quality by the network device and the link self-adaptation, which leads in turn to fluctuations in uplink throughput. If the network device is enabled to better understand these constraints and the impact on the terminal's behavior, more detailed and accurate scheduling decisions can be made by the network device.

Two types of RF exposure level limit indexes can be used currently based on different combinations of frequency bands. One type of RF exposure level limit index can use Specific Absorption Rate (SAR) as a measurement index, which is mainly applicable to frequency bands lower than 6 GHz, such as Frequency Range 1 (FR1). Another type of RF exposure level limit index is to measure the power density (PD) and calculate Maximum Permissible Exposure (MPE) as a measurement index, which is mainly used in the millimeter wave band, such as FR2. The above indexes both use the time averaging way to limit the RF exposure. That is, when using the above indexes to measure the RF exposure, an average RF exposure measured within a specific time window must be ensured to be below a certain threshold. It should be noted that it is the average RF exposure, not instantaneous RF exposure, which is specified in the protocols. In some embodiments, there may be some exceptions in specific regions. The time averaging property of the above constraints is a crucial aspect when high-power transmission is achieved at the terminal. This indicates that although the terminal cannot always transmit at full power in all frequency bands, it can transmit higher transmit power in a short period of time.

When the terminal is performing the uplink transmission, the terminal will determine, according to SAR/MEP requirements, in the initial access stage, a maximum uplink transmission cycle that the terminal can support in an uplink evaluation period, and report the maximum uplink transmission cycle to the network. After the communication link is established, the network device will configure a value of maxUplinkDutyCycle to be used in subsequent transmissions for the terminal based on the maximum uplink transmission cycle reported by the terminal. The terminal controls an actual uplink transmission based on the percentage of transmission symbols corresponding to the maxUplinkDutyCycle configured by the network device during the uplink evaluation period, and the resulted adjustments are transparent to the network device. Due to regulations in some countries/regions, mandatory radiation exposure requirements for SAR/MEP may be imposed on terminals in different frequency bands. The terminal performs the actual transmission to meet the requirements of the uplink duty cycle during the uplink evaluation period, so that the requirements of SAR/MEP can be made to be met. For example, FIG. 2 shows a schematic diagram of cumulative transmit power control for a terminal. As shown in FIG. 2, the gray area shows the total transmit power of the terminal within one uplink duty cycle, which needs to meet the transmit power limit. The transmit power limit can be a power limit (SAR limit) determined by the terminal on the carrier/in the cell to meet the requirements of SAR/MEP, such as 23 dBm. In FIG. 2, the terminal maintains an average transmit power within the uplink duty cycle to meet the transmit power limit. In fact, in some transmission time slots, the transmit power of the terminal can be lower than the transmit power limit, while in some other transmission time slots, the transmit power of the terminal can be higher than the transmit power limit, as shown in a schematic diagram of a power arrangement in FIG. 3. As shown in FIG. 3, it can be seen that the terminal only needs to ensure that the average transmit power on the transmission symbols corresponding to the actual uplink duty cycle during the uplink evaluation period does not exceed the transmit power limit. In some embodiments, although the instantaneous transmit power in a certain time slot can exceed the transmit power limit, the requirements of the maximum transmit power of the terminal are still needed to be met, that is, the instantaneous transmit power cannot exceed the maximum transmit power of the terminal.

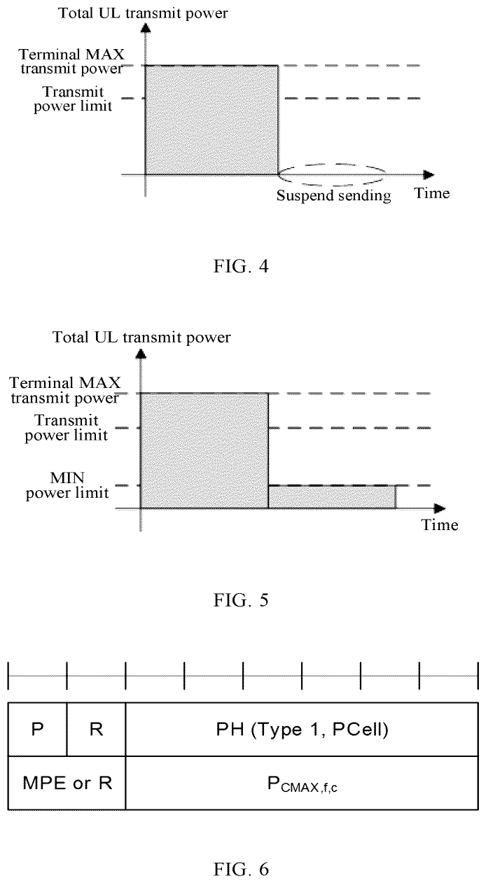

In some cases, as shown in FIG. 4, the terminal may use the maximum transmit power to send uplink data in some time slots, and in order to ensure that the average transmit power on the transmission symbols corresponding to the actual uplink duty cycle during the uplink evaluation period meets the requirements of the transmit power limit, the terminal being unable to send uplink data in the future may be resulted, even if the terminal has a need to send data during this period, the terminal cannot continue to send the data. In other cases, as shown in FIG. 5, after using the maximum transmit power to send uplink data in some time slots, in order to ensure that the average transmit power on the transmission symbols corresponding to the actual uplink duty cycle during the uplink evaluation period meets the requirements of the transmit power limit, the terminal can only use the minimum transmit power to send the uplink data during the subsequent period. The minimum transmit power can also be referred to as the minimum transmit power limit, which represents the minimum transmit power that can be used by the terminal to send the uplink data. If the transmit power is lower than the minimum transmit power limit, the uplink data cannot be sent by the terminal.

According to some specifications, the terminal can use the value of maxUplinkDutyCycle to avoid SAR/MEP issues for the high power user equipment (HPUE) for non-CA situations. For CA situations, the issues can be avoided through UE arrangement.

According to specifications for Radio Access Network 4 (RAN4), for example, for a PC2 (26 dBm) terminal, the actual transmit power and the probability of the transmit power that is higher than the default transmit power (23 dBm) in a frequency band depend on the terminal arrangement, ensuring that the SAR/MEPE requirements are met within the maximum uplink duty cycle during the uplink evaluation period. When the transmission does not exceed the maximum uplink duty cycle during the uplink evaluation period, a maximum power class of 26 dBm can be used for transmission. However, if the transmission has already exceeded the maximum uplink duty cycle during the uplink evaluation period, the transmit power class of the terminal needs to be degraded to PC3, which is 23 dBm, during subsequent transmission periods. According to specifications for RAN4 in R17, the maximum transmit power of the inter-band CA and the inter-band EN-DC (Evolved Universal Terrestrial Radio Access-New Radio Dual Connection) can be a sum of maximum transmit power values of the aggregated frequency bands, which also depends on the terminal arrangement, similar with conditions considered for the probability of the transmit power that is higher than the default transmit power (23 dBm) in a frequency band, ensuring that the SAR/MEPE requirements are met within the maximum uplink duty cycle during the uplink evaluation period.

The transmit power of the terminal can vary based on the terminal arrangement, and these operations are transparent to the network device. Therefore, the terminal can report the instantaneous transmit power for the Physical Uplink Shared Channel (PUSCH) transmission to the network device. For example, the terminal can report the instantaneous transmit power for the PUSCH transmission to the network device through the Power Headroom Report (PHR). The PHR can include Power Headroom (PH), Maximum transmit power P_{CMAX,f,c}, and Power Management Maximum Power Reduction (P-MPR). In some embodiments, the Power Headroom reflects the additional transmit power amount that can be sent by the terminal with reference to a current PUSCH power level, and P_{CMAX,f,c} reflects the maximum power that can be sent by the terminal in this situation.

However, currently, according to the protocol, the P-MPR is only used for the FR2 frequency band, meaning that only the PHR sent by the terminal in the FR2 frequency band includes MPR determined based on MPE requirements, while the PHR sent by the terminal in the FR1 frequency band does not include MPR determined based on SAR requirements.

At present, the PHR reported by the terminal includes a single-carrier based PHR and a multi-carrier based PHR.

FIG. 6 shows a single-carrier PHR configuration format, which mainly includes a P indication field, an R indication field, an MPE indication field, a PH indication field, and a P_{CMAX,f,c} indication field.

In some embodiments, the P indication field is configured to indicate whether there is an MPR based on MPE requirements to be reported.

The R indication field is a reserved indication field, and is mainly configured to record newly added data correspondingly when needed.

The MPE indication field is configured to indicate an MPR value based on MPE requirements when the P indication field indicates that there is an MPR based on MPE requirements to be reported.

The PH indication field is configured to indicate transmit power headroom that can be sent by the terminal when the terminal accesses a primary cell (PCell) under a type 1 (PUSCH).

The P_{CMAX,f,c} indication field is configured to indicate a maximum transmit power that can be sent by the terminal.

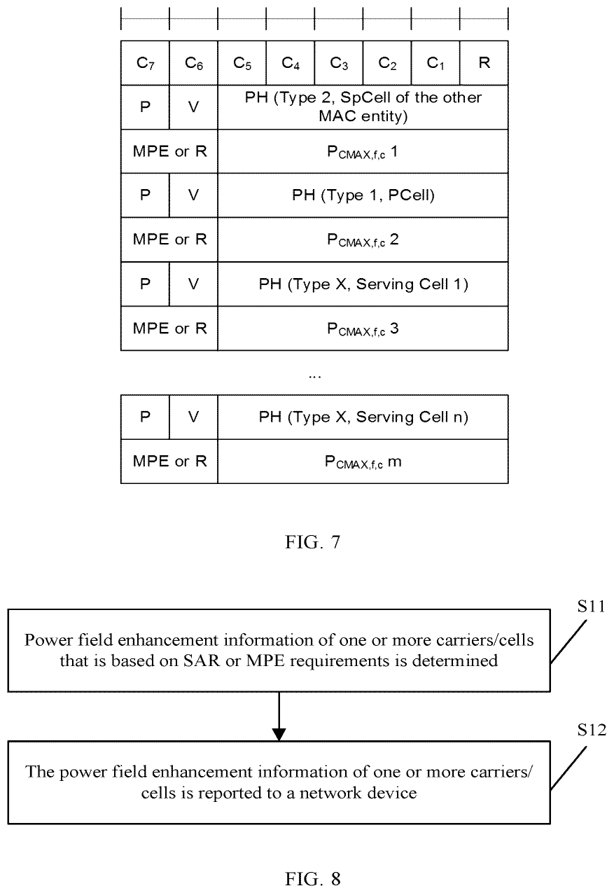

FIG. 7 shows a multi-carrier PHR configuration format. In some embodiments, C₁ to C₇ can be configured to indicate different carriers. It can be understood that the multi-carrier PHR can be seen as a combination of multiple single-carrier PHRs. Type 2 can correspond to the Physical Uplink Control Channel (PUCCH), and the special cell (SpCell) can include a PCell and a primary secondary cell (PSCell). The serving cell can be PCell, secondary cell (SCell), PSCell, SpCell, etc.

Although the network device can learn part of the power situation of the terminal based on the PHR reported by the terminal, the reason for the changes in the transmit power caused by SAR/MEP requirements on the terminal is still unknown for the network device.

In the related art, due to the fact that the RF exposure varies over time, a new mechanism has been introduced for the terminal to report the availability of the transmit power to the network device. In some schemes, the terminal can periodically report available energy to the network device, which can be achieved by independently sending or sending together with the PHR, an Energy Headroom Report (EHR) or an Energy Availability Report (EAR) to the network device. For different component carriers (CC), the terminal will perform the uplink transmission according to different transmit power limits. Within a time window of the uplink duty cycle, the cumulative power reported by the PHR determines a capacity level for the remaining time in the window. This report can be made through a new definition way, which supports the network device to learn about the impact of SAR/MEP requirements on subsequent transmissions.

In the research requirements of R18, the uplink coverage has always been one of the bottlenecks in the system performance, which can affect the signal quality and the user experience. There is a strong demand for uplink coverage enhancement, including operators. In the research on the coverage enhancement (CE) of R18, power domain enhancement is a topic worth discussing, as the power domain enhancement has the most direct effect on improving both the coverage and the spectral efficiency (SE).

In NR uplink CA/DC, the maximum transmit power defined on BC will be limited by the transmit power class of the terminal defined on the BC. The RAN4 enhancement of R17 supports HPUE to better utilize the independent PAs of the terminal to achieve higher transmit power, mainly enhancing the PC2+PC3 configuration.

When the terminal performs the uplink transmission, FR1 is limited by SAR requirements and FR2 is limited by MPE requirements, resulting limitations in the actual transmit power. The transmit power adjustment based on SAR and MPE requirements may also cause significant fluctuations or interruptions in the transmit power. Based on the RAN4 protocol, the terminal defines the arrangement to be transparent to the network device. Whether these power limits, power adjustments, and the HPUE can achieve the high-power transmission would greatly affect the scheduling by the network device, which will also directly affect the actual effectiveness of R17 enhancement in deployment and application in network devices.

Therefore, when the network device obtains the power information related to the terminal and understands corresponding behaviors of the terminal, that the network device will make better scheduling decisions can be supported. Therefore, how to achieve the reporting of power information and the corresponding mechanism and signaling is a problem that needs to be solved.

Embodiments of the present disclosure propose a method for reporting power information. By enhancing the power information, the terminal can be allowed to report the power field enhancement information of one or more carriers/cells that is based on SAR/MEP requirements. By sending the power field enhancement information to the network device, the network device can obtain the power field enhancement information of one or more carriers/cells that is based on SAR/MEP requirements, and understand the behaviors of the terminal, allowing the network device to make better scheduling decisions, and to perform scheduling that is more suitable for business transmission needs, so as to improve the system throughput and the user coverage, improve the system efficiency, and reduce ineffective scheduling. Moreover, due to the fact that the network device can obtain the power field enhancement information of one or more carriers/cells, the network device can schedule, based on the power field enhancement information, the terminal to achieve higher power transmission, thereby saving power of the terminal.

FIG. 8 is a flowchart of a method for reporting power information according to one or more embodiments. As shown in FIG. 8, the method for reporting the power information is performed by a terminal and includes the following steps.

In step S11, power field enhancement information of one or more carriers/cells that is based on SAR or MPE requirements is determined.

In some embodiments, the power field enhancement information includes one or more of Power Headroom (PH), Maximum Power Reduction (MPR), and transmit power information.

In some embodiments, the power field enhancement information includes PH, which is a PH value or a PH mapping value. The PH value or the PH mapping value is obtained through calculation based on an actual PUSCH transmitted by each carrier/cell in one or more carriers/cells, or the PH value or the PH mapping value is obtained through calculation based on a PUSCH reference configuration for each carrier/cell in one or more carriers/cells.

In some embodiments, the power field enhancement information includes MPR, and the MPR corresponding to each carrier/cell is determined based on SAR requirements under FR1 or MPE requirements under FR2.

In some embodiments, the power field enhancement information includes transmit power information, and the transmit power information is configured to determine a transmit power used by one or more carriers/cells when sending data.

In step S12, the power field enhancement information of one or more carriers/cells is reported to a network device.

In embodiments of the present disclosure, by enhancing the power information of one or more carriers/cells, after reporting the power field enhancement information of one or more carriers/cells to the network device, the network device can obtain, based on the power field enhancement information of one or more carriers/cells, the power information that is based on SAR/MEP requirements, thereby understanding the behaviors of the terminal, allowing the network device to make better scheduling decisions, and to perform scheduling that is more suitable for business transmission needs, so as to improve the system throughput and the user coverage, improve the system efficiency, and reduce ineffective scheduling. Moreover, due to the fact that the network device can obtain the power field enhancement information of one or more carriers/cells, the network device can schedule, based on the power field enhancement information, the terminal to achieve higher power transmission, thereby saving power of the terminal.

In the method for reporting power information provided in embodiments of the present disclosure, the power field enhancement information includes the transmit power information, and the transmit power information includes at least one of the following:
a maximum transmit power;
a power class type;
a power class adjustment amount;
a power class adjustment direction.

In some embodiments, the maximum transmit power indicates the maximum transmit power currently supported by the terminal. The power class type indicates a defined terminal class, and the maximum transmit power of the terminal is limited by the defined terminal class. The power class adjustment amount indicates an adjustment amount for the power class type of the terminal. The power class adjustment direction indicates whether to upgrade the class or to degrade the class when adjusting the power class type of the terminal.

For example, a terminal with a power class PC2 supports a maximum transmit power of 26 dBm, while a terminal with a power class PC3 supports a maximum transmit power of 23 dBm. When the power class type of the terminal is adjusted from PC2 to PC3, that is, the power class adjustment amount is 1, and the power class adjustment direction is upgrading the class. For example, if the power class type of the terminal is adjusted from PC3 to PC2, then the power class adjustment amount is 1, and the power class adjustment direction is degrading the class. In embodiments of the present disclosure, when the power field enhancement information reported by the terminal includes the transmit power information, the network device can obtain how the transmit power is adjusted based on SAR/MEP requirements, and understand the corresponding behaviors of the terminal, so that the network device can perform better scheduling on the terminal based on the transmit power information.

In the method for reporting power information provided in embodiments of the present disclosure, when the power field enhancement information includes the Power Headroom, the power headroom of each carrier/cell can be reported separately. The power headroom of different carriers/cells can be included in the same signaling, or the power headroom of different carriers/cells can be included in different signaling.

In the method for reporting power information provided in embodiments of the present disclosure, when the power field enhancement information includes the Maximum Power Reduction, the terminal can report the maximum power reduction of each carrier/cell separately. The maximum power reduction of different carriers/cells can be included in the same signaling, or the maximum power reduction of different carriers/cells can be included in different signaling.

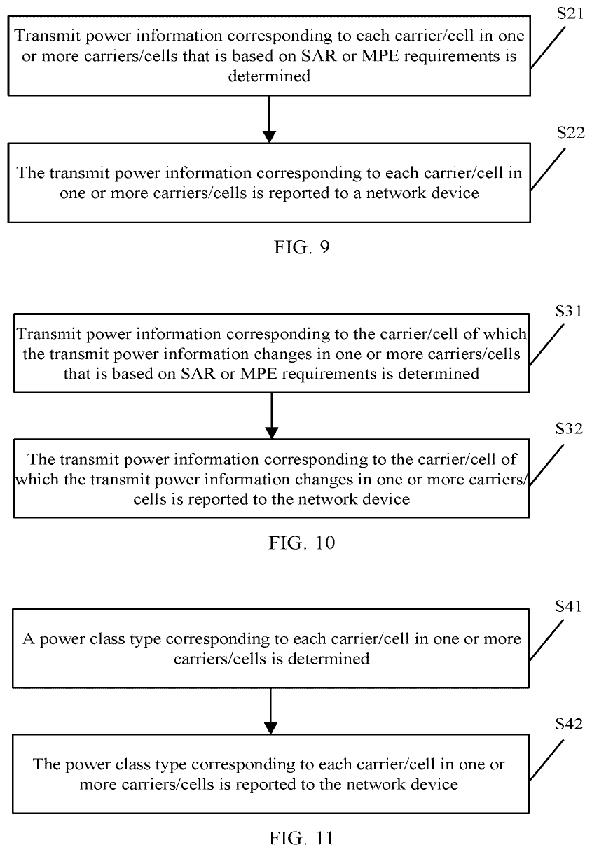

In the method for reporting power information provided in embodiments of the present disclosure, when the power field enhancement information includes the transmit power information, the terminal can report the transmit power information corresponding to each carrier/cell in one or more carriers/cells to the network device. Based on this, embodiments of the present disclosure provide a method for reporting transmit power information. As shown in FIG. 9, the method includes the following steps.

In step S21, transmit power information corresponding to each carrier/cell in one or more carriers/cells that is based on SAR or MPE requirements is determined.

In step S22, the transmit power information corresponding to each carrier/cell in one or more carriers/cells is reported to a network device.

In some embodiments, the transmit power information corresponding to different carriers/cells is included in the same signaling, or the transmit power information corresponding to different carriers/cells is included in different signaling.

In some embodiments, different transmit power information corresponding to the same carrier/cell is included in the same signaling, or different transmit power information corresponding to the same carrier/cell is included in different signaling.

In the method for reporting power information provided in embodiments of the present disclosure, when the power field enhancement information includes the transmit power information, the terminal can report to the network device the transmit power information corresponding to some carrier(s)/cell(s) in one or more carriers/cells, where the transmit power information of the carrier(s)/cell(s) reported has changed. Based on this, embodiments of the present disclosure provide a method for reporting transmit power information. As shown in FIG. 10, the method includes the following steps.

In step S31, transmit power information corresponding to the carrier/cell of which the transmit power information changes in one or more carriers/cells that is based on SAR or MPE requirements is determined.

In step S32, the transmit power information corresponding to the carrier/cell of which the transmit power information changes in one or more carriers/cells is reported to the network device.

In embodiments of the present disclosure, by determining one or more types of the power field enhancement information, the terminal is allowed to be more flexible in reporting the power field enhancement information.

In the method for reporting power information provided in embodiments of the present disclosure, when the terminal reports the transmit power information corresponding to the carrier/cell of which the transmit power information changes in one or more carriers/cells, the transmit power information corresponding to the carrier/cell of which the transmit power information changes is included in an information indication field, and the information indication field is configured to indicate that the transmit power information changes or the transmit power information does not change.

In some embodiments, each type of information included in the transmit power information is separately included in an independent information indication field. That is, whether different transmit power information of one or more carriers/cells changes or not is indicated through different information indication fields.

In embodiments of the present disclosure, the terminal can report the transmit power information corresponding to the carrier/cell of which the transmit power information changes in one or more carriers/cells, thereby saving signaling consumption.

In the method for reporting power information provided in embodiments of the present disclosure, that the transmit power information changes includes at least one of the following:
that the power class type changes;
that the power class adjustment direction changes.

In embodiments of the present disclosure, the terminal reports to the network device the transmit power information corresponding to the carrier/cell of which the transmit power information changes, to allow the network device to obtain the power information related to the carrier/cell of which the transmit power information has changed, while saving the signaling consumption, so that the network device can understand the behaviors of the terminal, and make better scheduling decisions.

In the method for reporting power information provided in embodiments of the present disclosure, if that the transmit power information changes includes that the power class type changes, the information indication field includes a first information indication field, and the first information indication field is configured to indicate that the power class type changes or that the power class type does not change.

In some embodiments, each carrier/cell in one or more carriers/cells corresponds to a first information indication field, and the different bit values of the first information indication fields indicate whether the power class type of the corresponding carrier/cell changes.

For example, when the bit value of the first information indication field is 0, it indicates that the power class type of the corresponding carrier/cell does not change. When the bit value of the first information indication field is 1, it indicates that the power class type of the corresponding carrier/cell changes.

In the method for reporting power information provided in embodiments of the present disclosure, if that the transmit power information changes includes that the power class adjustment direction changes, the information indication field includes a second information indication field, and the second information indication field is configured to indicate the power class adjustment direction of the carrier/cell of which the power class adjustment direction changes.

In some embodiments, different code points in the second information indication field indicate different power class adjustment directions of one or more carriers/cells.

In some embodiments, taking two carriers/cells as an example, two bits can be used to indicate whether the power classes of the two carriers/cells have been adjusted based on the power reduction, as shown in Table 2.

TABLE 2

| Code point | Carrier 1/Cell 1 | Carrier 2/Cell 2 |
|---|---|---|
| 00 | No change | No change |
| 01 | PC degrade | No change |
| 10 | No change | PC degrade |
| 11 | PC degrade | PC degrade |

In some embodiments, taking two carriers/cells as an example, three bits can be used to indicate whether the power classes of the two carriers/cells have been adjusted based on power reduction or power elevation, as shown in Table 3.

TABLE 3

| Code point | Carrier 1/Cell 1 | Carrier 2/Cell 2 |
|---|---|---|
| 000 | No change | No change |
| 001 | Reduction | No change |
| 010 | No change | Reduction |
| 011 | Reduction | Reduction |
| 100 | Elevation | No change |
| 101 | No change | Elevation |
| 110 | Reserved | Reserved |
| 111 | Reserved | Reserved |

In some embodiments, in consideration that some power class adjustment directions corresponding to multiple carriers/cells may not occur in practical situations, such as the situation where two carriers/cells simultaneously upgrade their classes, Table 3 does not provide all power class adjustment directions in the second information indication field, only relatively reasonable power class adjustment directions are kept. By reserving code points in the second information indication field and redefining the reserved code points, some situations where special power class adjustment directions for carriers/cells in actual situations occur can be indicated. In the method for reporting power information provided in embodiments of the present disclosure, when the power field enhancement information includes the transmit power information, the terminal can report the power class type corresponding to each carrier/cell in one or more carriers/cells to the network device. Based on this, embodiments of the present disclosure also provide a method for reporting a power class type. As shown in FIG. 11, the method includes the following steps.

In step S41, a power class type corresponding to each carrier/cell in one or more carriers/cells is determined.

In step S42, the power class type corresponding to each carrier/cell in one or more carriers/cells is reported to the network device.

In some embodiments, the network device can determine whether a transmit power adjustment occurs in a carrier/cell based on the power class type corresponding to the carrier/cell.

In some embodiments, the information indication field includes a third information indication field, and the third information indication field is configured to indicate whether the power class type of each carrier/cell in one or more carriers/cells is the default power class type.

In some embodiments, if the third information indication field indicates that the power class type of a certain carrier/cell is the default power class type, then it is determined that no transmit power adjustments have occurred in the carrier/cell, that is, the power reduction has not occurred. If the third information indication field indicates that the power class type of a certain carrier/cell is not the default power class type, then it is determined that the transmit power adjustment has occurred in the carrier/cell, that is, the power reduction adjustment or the power elevation adjustment has occurred.

In embodiments of the present disclosure, the terminal can report the power class type corresponding to each carrier/cell in one or more carriers/cells to the network device, enabling the network device to determine whether a power class adjustment has occurred in the carriers/cells, so that the network device can perform better scheduling on the terminal based on the power class adjustment.

In the method for reporting power information provided in embodiments of the present disclosure, different bit values of different bits in the third information indication field are configured to indicate the power class types of different carriers/cells.

For example, taking the number of carriers/cells as N as an example, the third information indication field can include N bits, indicating the power class types of different carriers/cells through different values of N bits. Alternatively, the third information indication field can include N bits, each of which corresponds to a carrier/cell, and different bit values of each bit are configured to indicate whether the power class type of the carrier/cell is the default power class type.

In the method for reporting power information provided in embodiments of the present disclosure, the information indication domain is included in at least one of the following signaling:
a newly defined Media Access Control-Control Element (MAC-CE), which is configured to include the EHR;
Radio Resource Control (RRC) signaling;
Uplink Control Information (UCI).

In embodiments of the present disclosure, the information indication field including the power field enhancement information can be included in one or more different signaling, so that the terminal can more flexible reporting when report the power field enhancement information.

In the method for reporting power information provided in embodiments of the present disclosure, multiple carriers/cells correspond to multiple frequency ranges.

In some embodiments, multiple frequency ranges include one of the following combinations:
a combination of FR1 and FR1;
a combination of FR1 and FR2;
a combination of FR2 and FR2.

In some embodiments, under FR1, the power field enhancement information includes the MPR determined based on SAR requirements, and under FR2, the power field enhancement information includes the MPR determined based on MPE requirements.

In embodiments of the present disclosure, the terminal can report the MPR caused by SAR or MPE requirements for one or more carriers/cells to the network device under FR1 and FR2, so that the network device can understand the behaviors of the terminal and achieve better scheduling.

In the method for reporting power information provided in embodiments of the present disclosure, the embodiments involved in the above can be applied to a single-carrier scenario, a carrier aggregation scenario, or a dual connection scenario.

In some embodiments, the carrier/cell is a carrier/cell in the single-carrier scenario, the carrier aggregation scenario, or the dual connection scenario.

In some embodiments, the multiple carriers/cells are carriers/cells in the carrier aggregation scenario or the dual connection scenario.

In embodiments of the present disclosure, the method for reporting power information can be applied to the single-carrier scenario, the carrier aggregation scenario, or the dual connection scenario, to achieve the reporting of the power field enhancement information for one or more carriers/cells, enabling the network device to understand the behaviors of the terminal and achieve better scheduling.

Based on the same concept, the present disclosure also provides a method for reporting power information performed by the network device.

FIG. 12 is a flowchart of a method for reporting power information according to one or more embodiments. As shown in FIG. 12, the method for reporting power information is performed by a network device and includes the following steps.

In step S51, power field enhancement information of one or more carriers/cells that is based on SAR or MPE requirements and sent by a terminal is received.

In some embodiments, the power field enhancement information includes one or more of Power Headroom (PH), Maximum Power Reduction (MPR), and transmit power information.

In some embodiments, the power field enhancement information includes PH, which is a PH value or a PH mapping value. The PH value or the PH mapping value is obtained through calculation based on an actual PUSCH transmitted by each carrier/cell in one or more carriers/cells, or the PH value or the PH mapping value is obtained through calculation based on a PUSCH reference configuration for each carrier/cell in one or more carriers/cells.

In some embodiments, the power field enhancement information includes MPR, and the MPR corresponding to each carrier/cell is determined based on SAR requirements under FR1 or MPE requirements under FR2.

In some embodiments, the power field enhancement information includes transmit power information, and the transmit power information is configured to determine a transmit power used by one or more carriers/cells when sending data.

In embodiments of the present disclosure, by enhancing the power information of one or more carriers/cells, after the terminal reports the power field enhancement information of one or more carriers/cells to the network device, the network device can obtain, based on the power field enhancement information of one or more carriers/cells, the power information that is based on SAR/MEP requirements, thereby understanding the behaviors of the terminal, allowing the network device to make better scheduling decisions, and to perform scheduling that is more suitable for business transmission needs, so as to improve the system throughput and the user coverage, improve the system efficiency, and reduce ineffective scheduling. Moreover, due to the fact that the network device can obtain the power field enhancement information of one or more carriers/cells, the network device can schedule, based on the power field enhancement information, the terminal to achieve higher power transmission, thereby saving power of the terminal.

In the method for reporting power information provided in embodiments of the present disclosure, the power field enhancement information includes the transmit power information, and the transmit power information includes at least one of the following:
a maximum transmit power;
a power class type;
a power class adjustment amount;
a power class adjustment direction.

In some embodiments, the maximum transmit power indicates the maximum transmit power currently supported by the terminal. The power class type indicates a defined terminal class, and the maximum transmit power of the terminal is limited by the defined terminal class. The power class adjustment amount indicates an adjustment amount for the power class type of the terminal. The power class adjustment direction indicates whether to upgrade the class or to degrade the class when adjusting the power class type of the terminal.

For example, a terminal with a power class PC2 supports a maximum transmit power of 26 dBm, while a terminal with a power class PC3 supports a maximum transmit power of 23 dBm. When the power class type of the terminal is adjusted from PC2 to PC3, that is, the power class adjustment amount is 1, and the power class adjustment direction is upgrading the class. For example, if the power class type of the terminal is adjusted from PC3 to PC2, then the power class adjustment amount is 1, and the power class adjustment direction is degrading the class.

In the method for reporting power information provided in embodiments of the present disclosure, when the power field enhancement information includes the Power Headroom, the power headroom of each carrier/cell can be reported separately. The power headroom of different carriers/cells can be included in the same signaling, or the power headroom of different carriers/cells can be included in different signaling.

In the method for reporting power information provided in embodiments of the present disclosure, when the power field enhancement information includes the Maximum Power Reduction, the terminal can report the maximum power reduction of each carrier/cell separately. The maximum power reduction of different carriers/cells can be included in the same signaling, or the maximum power reduction of different carriers/cells can be included in different signaling.

In the method for reporting power information provided in embodiments of the present disclosure, when the power field enhancement information includes the transmit power information, the network device can receive the transmit power information corresponding to each carrier/cell in one or more carriers/cells reported by the terminal. Based on this, embodiments of the present disclosure provide a method for reporting transmit power information. As shown in FIG. 13, the method includes the following steps.

In step S61, transmit power information corresponding to each carrier/cell in one or more carriers/cells that is based on SAR or MPE requirements and sent by the terminal is received.

In some embodiments, the transmit power information corresponding to different carriers/cells is included in the same signaling, or the transmit power information corresponding to different carriers/cells is included in different signaling.

In some embodiments, different transmit power information corresponding to the same carrier/cell is included in the same signaling, or different transmit power information corresponding to the same carrier/cell is included in different signaling.

In the method for reporting power information provided in embodiments of the present disclosure, when the power field enhancement information includes the transmit power information, the network device can receive the transmit power information corresponding to some carrier(s)/cell(s) in one or more carriers/cells reported by the terminal, where the transmit power information of the carrier(s)/cell(s) reported has changed. Based on this, embodiments of the present disclosure provide a method for reporting transmit power information. As shown in FIG. 14, the method includes the following steps.

In step S71, transmit power information corresponding to the carrier/cell of which the transmit power information changes in one or more carriers/cells sent by the terminal is received.

In embodiments of the present disclosure, the terminal reports one or more types of the power field enhancement information, so that the terminal is allowed to be more flexible in reporting the power field enhancement information.

In the method for reporting power information provided in embodiments of the present disclosure, when the terminal reports the transmit power information corresponding to the carrier/cell of which the transmit power information changes in one or more carriers/cells, the transmit power information corresponding to the carrier/cell of which the transmit power information changes is included in an information indication field, and the information indication field is configured to indicate that the transmit power information changes or the transmit power information does not change.

In some embodiments, each type of information included in the transmit power information is separately included in an independent information indication field. That is, whether different transmit power information of one or more carriers/cells changes or not is indicated through different information indication fields.

In embodiments of the present disclosure, the terminal can report the transmit power information corresponding to the carrier/cell of which the transmit power information changes in one or more carriers/cells, thereby saving signaling consumption.

In the method for reporting power information provided in embodiments of the present disclosure, that the transmit power information changes includes at least one of the following:
that the power class type changes;
that the power class adjustment direction changes.

In embodiments of the present disclosure, the terminal reports to the network device the transmit power information corresponding to the carrier/cell of which the transmit power information changes, to allow the network device to obtain the power information related to the carrier/cell of which the transmit power information has changed, while saving the signaling consumption, so that the network device can understand the behaviors of the terminal, and make better scheduling decisions.

In the method for reporting power information provided in embodiments of the present disclosure, if that the transmit power information changes includes that the power class type changes, the information indication field includes a first information indication field, and the first information indication field is configured to indicate that the power class type changes or that the power class type does not change.

In some embodiments, each carrier/cell in one or more carriers/cells corresponds to a first information indication field, and the different bit values of the first information indication fields indicate whether the power class type of the corresponding carrier/cell changes.

For example, when the bit value of the first information indication field is 0, it indicates that the power class type of the corresponding carrier/cell does not change. When the bit value of the first information indication field is 1, it indicates that the power class type of the corresponding carrier/cell changes.

In the method for reporting power information provided in embodiments of the present disclosure, if that the transmit power information changes includes that the power class adjustment direction changes, the information indication field includes a second information indication field, and the second information indication field is configured to indicate the power class adjustment direction of the carrier/cell of which the power class adjustment direction changes.

In some embodiments, different code points in the second information indication field indicate different power class adjustment directions of one or more carriers/cells.

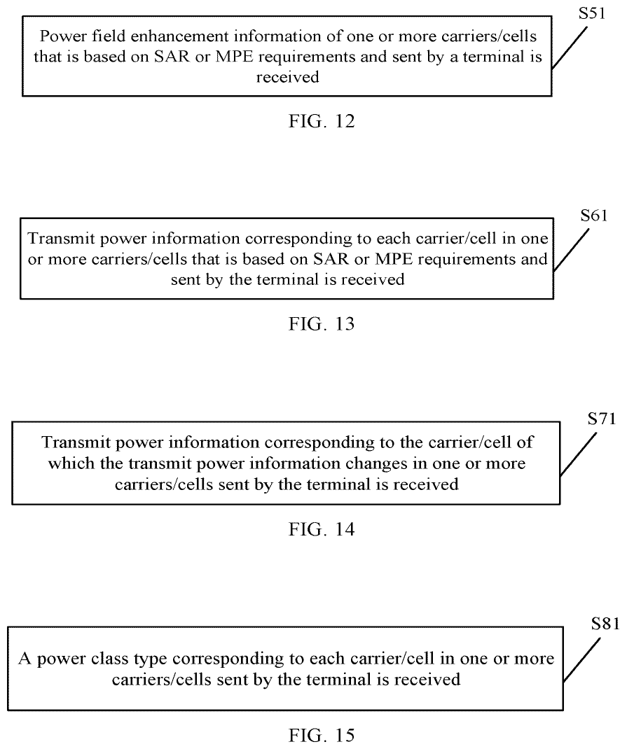

In the method for reporting power information provided in embodiments of the present disclosure, when the power field enhancement information includes the transmit power information, the network device can receive the power class type corresponding to each carrier/cell in one or more carriers/cells reported by the terminal. Based on this, embodiments of the present disclosure also provide a method for reporting a power class type. As shown in FIG. 15, the method includes the following steps.

In step S81, a power class type corresponding to each carrier/cell in one or more carriers/cells sent by the terminal is received.

In some embodiments, the network device can determine whether a transmit power adjustment occurs in a carrier/cell based on the power class type corresponding to the carrier/cell.

In some embodiments, the information indication field includes a third information indication field, and the third information indication field is configured to indicate whether the power class type of each carrier/cell in one or more carriers/cells is the default power class type.

In some embodiments, if the third information indication field indicates that the power class type of a certain carrier/cell is the default power class type, then it is determined that no transmit power adjustments have occurred in the carrier/cell, that is, the power reduction has not occurred. If the third information indication field indicates that the power class type of a certain carrier/cell is not the default power class type, then it is determined that the transmit power adjustment has occurred in the carrier/cell, that is, the power reduction adjustment or the power elevation adjustment has occurred.

In embodiments of the present disclosure, the terminal can report the power class type corresponding to each carrier/cell in one or more carriers/cells to the network device, enabling the network device to determine whether a power class adjustment has occurred in the carriers/cells, so that the network device can perform better scheduling on the terminal based on the power class adjustment.

In the method for reporting power information provided in embodiments of the present disclosure, different bit values of different bits in the third information indication field are configured to indicate the power class types of different carriers/cells.

For example, taking the number of carriers/cells as N as an example, the third information indication field can include N bits, indicating the power class types of different carriers/cells through different values of N bits. Alternatively, the third information indication field can include N bits, each of which corresponds to a carrier/cell, and different bit values of each bit are configured to indicate whether the power class type of the carrier/cell is the default power class type.

In the method for reporting power information provided in embodiments of the present disclosure, the information indication domain is included in at least one of the following signaling:
a newly defined Media Access Control-Control Element (MAC-CE), which is configured to include the HER;
Radio Resource Control (RRC) signaling;
Uplink Control Information (UCI).

In embodiments of the present disclosure, the information indication field including the power field enhancement information can be included in one or more different signaling, so that the terminal can more flexible reporting when report the power field enhancement information.

In the method for reporting power information provided in embodiments of the present disclosure, multiple carriers/cells correspond to multiple frequency ranges.

In some embodiments, multiple frequency ranges include one of the following combinations:
a combination of FR1 and FR1;
a combination of FR1 and FR2;
a combination of FR2 and FR2.

In some embodiments, under FR1, the power field enhancement information includes the MPR determined based on SAR requirements, and under FR2, the power field enhancement information includes the MPR determined based on MPE requirements.

In embodiments of the present disclosure, the terminal can report the MPR caused by SAR or MPE requirements for one or more carriers/cells to the network device under FR1 and FR2, so that the network device can understand the behaviors of the terminal and achieve better scheduling.

In the method for reporting power information provided in embodiments of the present disclosure, the embodiments involved in the above can be applied to a single-carrier scenario, a carrier aggregation scenario, or a dual connection scenario.

In some embodiments, the carrier/cell is a carrier/cell in the single-carrier scenario, the carrier aggregation scenario, or the dual connection scenario.

In some embodiments, the multiple carriers/cells are carriers/cells in the carrier aggregation scenario or the dual connection scenario.

In embodiments of the present disclosure, the method for reporting power information can be applied to the single-carrier scenario, the carrier aggregation scenario, or the dual connection scenario, to achieve the reporting of the power field enhancement information for one or more carriers/cells, enabling the network device to understand the behaviors of the terminal and achieve better scheduling.

It should be noted that those skilled in the art can understand that various embodiments/implementations mentioned in the present disclosure can be used in conjunction with the aforementioned embodiments or used alone. Whether used alone or in conjunction with the aforementioned embodiments, the implementation principle is similar. In embodiments of the present disclosure, some embodiments are described as being configured together. Those skilled in the art can understand that these embodiments do not limit the present disclosure.

Based on the same concept, embodiments of the present disclosure also provide an apparatus for reporting power information.

It can be understood that the apparatus for reporting power information provided by embodiments of the present disclosure include a hardware structure and/or a software module corresponding to each function in order to realize the above functions. In combination with the units and algorithm steps in examples disclosed in embodiments of the present disclosure, embodiments of the present disclosure can be implemented in the form of hardware or a combination of hardware and computer software. Whether a function is implemented in the way of hardware or computer software driving the hardware depends on a specific application and design constraints of a technical solution. Those skilled in the art can use different methods to implement the described functions for each specific application, but such an implementation should not be considered beyond the scope of technical solutions of embodiments of the present disclosure.

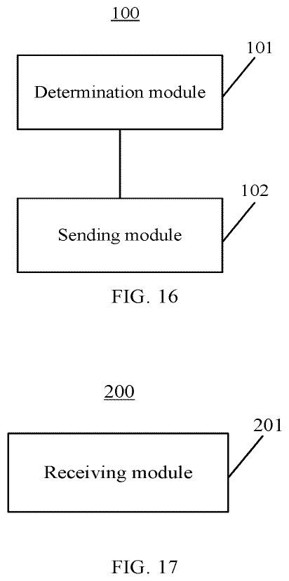

FIG. 16 is a block diagram of an apparatus for reporting power information according to one or more embodiments. As shown in FIG. 16, the apparatus 100 includes a determination module 101 and a sending module 102.

The determination module 101 is configured to determine power field enhancement information of one or more carriers/cells, the power field enhancement information being based on Specific Absorption Rate (SAR) or Maximum Permissible Exposure (MPE) requirements, and including one or more of Power Headroom, Maximum Power Reduction, and transmit power information.

The sending module 102 is configured to report the power field enhancement information of the one or more carriers/cells to a network device.

In some embodiments, the power field enhancement information includes the transmit power information, and the transmit power information includes at least one of the following:
a maximum transmit power;
a power class type;
a power class adjustment amount;
a power class adjustment direction.

In some embodiments, the sending module 102 is configured to report the transmit power information corresponding to each carrier/cell in the one or more carriers/cells to the network device.

In some embodiments, the sending module 102 is configured to report transmit power information corresponding to a carrier/cell of which the transmit power information changes in the one or more carriers/cells to the network device.

In some embodiments, the transmit power information corresponding to the carrier/cell of which the transmit power information changes is included in an information indication field, and the information indication field is configured to indicate whether the transmit power information changes or not.

In some embodiments, that the transmit power information changes includes at least one of the following:
that the power class type changes;
that the power class adjustment direction changes.

In some embodiments, that the transmit power information changes includes that the power class type changes, the information indication field includes a first information indication field, and the first information indication field is configured to indicate whether the power class type changes or not.

In some embodiments, that the transmit power information changes includes that the power class adjustment direction changes, the information indication field includes a second information indication field, and the second information indication field is configured to indicate a power class adjustment direction of a carrier/cell of which the power class adjustment direction changes.

In some embodiments, different code points in the second information indication field are configured to indicate different power class adjustment directions of the one or more carriers/cells.

In some embodiments, the sending module is configured to report the power class type corresponding to each carrier/cell in the one or more carriers/cells to the network device.

In some embodiments, the information indication field includes a third information indication field, and the third information indication field is configured to indicate whether the power class type of each carrier/cell in the one or more carriers/cells is a default power class type.

In some embodiments, different bit values of different bits in the third information indication field are configured to indicate the power class types of different carriers/cells.

In some embodiments, the information indication field is included in at least one of the following signaling:
a newly defined Media Access Control-Control Element (MAC-CE) configured to include an Energy Headroom Report (EHR);
Radio Resource Control (RRC) signaling;
Uplink Control Information (UCI).

In some embodiments, the carriers/cells correspond to multiple frequency ranges, and the multiple frequency ranges include one of the following combinations:
a combination of a Frequency Range 1 (FR1) and FR1;
a combination of FR1 and a Frequency Range 2 (FR2);
a combination of FR2 and FR2.

In some embodiments, one of the carriers/cells is a carrier/cell in a single-carrier scenario, a carrier aggregation scenario, or a dual connection scenario, and multiple of the carriers/cells are carriers/cells in the carrier aggregation scenario or the dual connection scenario.

As for the apparatus in the above embodiments, specific ways in which each module performs the function has been described in detail in the method embodiments, which will not be described in detail here.

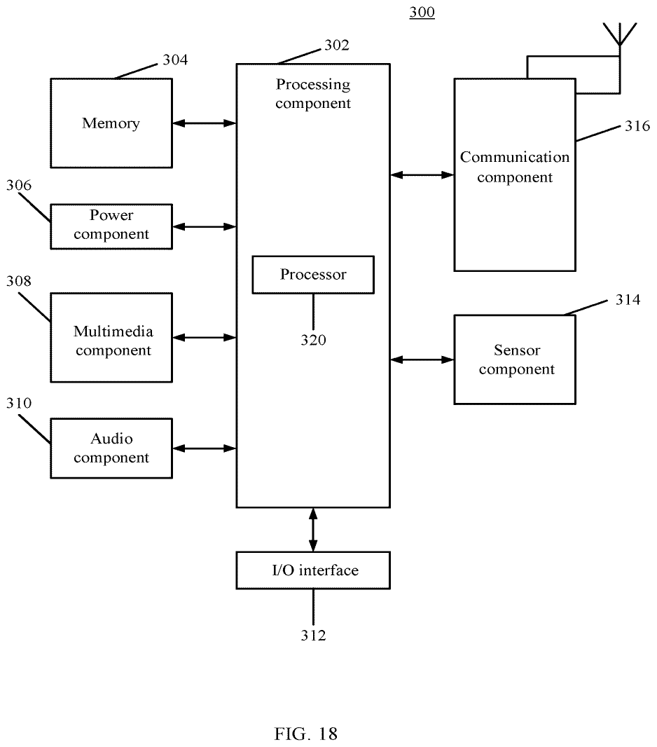

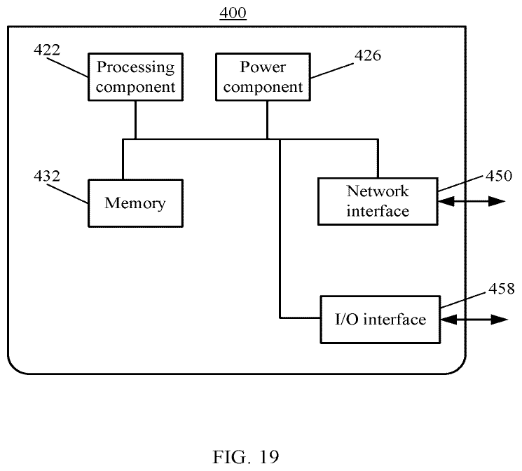

FIG. 17 is a block diagram of an apparatus for reporting power information according to one or more embodiments. As shown in FIG. 17, the apparatus 200 includes a receiving module 201.

The receiving module 201 is configured to receive power field enhancement information of one or more carriers/cells sent by a terminal, the power field enhancement information being based on Specific Absorption Rate (SAR) or Maximum Permissible Exposure (MPE) requirements, and including one or more of Power Headroom, Maximum Power Reduction, and transmit power information.

In some embodiments, the power field enhancement information includes the transmit power information, and the transmit power information includes at least one of the following:
a maximum transmit power;
a power class type;
a power class adjustment amount;
a power class adjustment direction.

In some embodiments, the receiving module 201 is configured to receive the transmit power information corresponding to each carrier/cell in the one or more carriers/cells sent by the terminal, the transmit power information being based on the SAR or the MPE requirements.

In some embodiments, the receiving module 201 is configured to receive transmit power information corresponding to a carrier/cell of which the transmit power information changes in the one or more carriers/cells sent by the terminal.

In some embodiments, the transmit power information corresponding to the carrier/cell of which the transmit power information changes is included in an information indication field, and the information indication field is configured to indicate whether the transmit power information changes or not.

In some embodiments, that the transmit power information changes includes at least one of the following:
that the power class type changes;
that the power class adjustment direction changes.

In some embodiments, that the transmit power information changes includes that the power class type changes, the information indication field includes a first information indication field, and the first information indication field is configured to indicate whether the power class type changes or not.

In some embodiments, that the transmit power information changes includes that the power class adjustment direction changes, the information indication field includes a second information indication field, and the second information indication field is configured to indicate a power class adjustment direction of a carrier/cell of which the power class adjustment direction changes.

In some embodiments, different code points in the second information indication field are configured to indicate different power class adjustment directions of the one or more carriers/cells.

In some embodiments, the receiving module 201 is configured to receive the power class type corresponding to each carrier/cell in the one or more carriers/cells sent by the terminal.

In some embodiments, the information indication field includes a third information indication field, and the third information indication field is configured to indicate whether the power class type of each carrier/cell in the one or more carriers/cells is a default power class type.

In some embodiments, different bit values of different bits in the third information indication field are configured to indicate the power class types of different carriers/cells.

In some embodiments, the information indication domain is included in at least one of the following signaling:
a newly defined Media Access Control-Control Element (MAC-CE) configured to include an Energy Headroom Report (EHR);
Radio Resource Control (RRC) signaling;
Uplink Control Information (UCI).

In some embodiments, the carriers/cells correspond to multiple frequency ranges, and the multiple frequency ranges include one of the following combinations:
a combination of a Frequency Range 1 (FR1) and FR1;
a combination of FR1 and a Frequency Range 2 (FR2);
a combination of FR2 and FR2.

In some embodiments, one of the carriers/cells is a carrier/cell in a single-carrier scenario, a carrier aggregation scenario, or a dual connection scenario, and multiple of the carriers/cells are carriers/cells in the carrier aggregation scenario or the dual connection scenario.

As for the apparatus in the above embodiments, specific ways in which each module performs the function has been described in detail in the method embodiments, which will not be described in detail here.

It should be noted that various modules/units involved in the apparatus 100 for reporting power information and the apparatus 200 for reporting power information provided in embodiments of the present disclosure are only illustrative and not limited to this. For example, the apparatus 100 for reporting power information in embodiments of the present disclosure can further include a receiving unit and/or a processing unit. The apparatus 200 for reporting power information can further include a sending unit and/or a processing unit. In some embodiments, the units included in the apparatus 100 for reporting power information and the apparatus 200 for reporting power information can interact with each other or with other network element devices.

FIG. 18 is a block diagram of a device 300 for reporting power information according to one or more embodiments. For example, the device 300 can be a mobile phone, a computer, a digital broadcasting user device, a messaging device, a game console, a tablet device, a medical device, a fitness device, a personal digital assistant, etc.

As shown in FIG. 18, the device 300 can include at least one of the following components: a processing component 302, a memory 304, a power component 306, a multimedia component 308, an audio component 310, an input/output (I/O) interface 312, a sensor component 314, and a communication component 316.

The processing component 302 typically controls the overall operation of the device 300, such as operations associated with display, telephone call, data communication, camera operation, and recording operations. The processing component 302 may include one or more processors to execute instructions to complete all or part of the methods described above. In addition, the processing component 302 may include one or more modules to facilitate interactions between the processing component 302 and other components. For example, the processing component 302 may include a multimedia module to facilitate interaction between the multimedia component 308 and the processing component 302.

The memory 304 is configured to store various types of data to support operations in the device 300. Examples of such data include instructions, contact data, phone book data, messages, pictures, videos, and the like for any application or method operating on the device 300. The memory 304 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 306 provides power for various components of the device 300. The power component 306 may include a power management system, one or more power supplies, and other components associated with generating, managing, and distributing power for the device 300.

The multimedia component 308 includes a display screen providing an output interface between the device 300 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 308 includes a front camera and/or a rear camera. When the device 300 is in operation mode, such as shooting mode or video mode, the front camera and/or rear camera can receive external multimedia data. Each front camera and rear camera can be a fixed optical lens system or have focal length and optical zoom capability.

The audio component 310 is configured to output and/or input audio signals. For example, the audio component 310 includes a microphone (MIC), which is configured to receive an external audio signal when the device 300 is in an operation mode, such as a calling mode, a recording mode, and a voice recognition mode. The received audio signal may be further stored in memory 304 or transmitted via communication component 316. In some embodiments, the audio component 310 also includes a speaker for outputting audio signals.

The I/O interface 312 provides an interface between the processing component 302 and peripheral interface modules, which can be a keyboard, click wheel, button, etc. These buttons may include, but are not limited to, the Home button, Volume button, Start button, and Lock button.

The sensor component 314 includes one or more sensors for providing various aspects of condition evaluation for the device 300. For example, the sensor component 314 can detect an open/closed state of the device 300, relative positioning of the components. The component is, for example, a display and a keypad of the device 300. The sensor component 314 can also detect changes in the position of the device 300 or one component of the device 300, presence or absence of the user's contact with the device 300, orientation or acceleration/deceleration of the device 300 and temperature change of the device 300. The sensor component 314 may include a proximity sensor configured to detect the presence of nearby objects without any physical contact. The sensor component 314 may also include a light sensor, such as a CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate wired or wireless communication between the device 300 and other devices. The device 300 can access wireless networks based on communication standards, such as WiFi, 2G or 3G, or a combination thereof. In some embodiments, the communication component 316 receives a broadcast signal or broadcast related information from an external broadcast management system via a broadcast channel. In some embodiments, the communication component 316 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the device 300 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 304 including instructions, which can be executed by a processor 320 of the device 300 to complete above methods. For example, the non-transitory computer-readable storage medium can be ROM, random access memory (RAM), CD-ROM, tapes, floppy disks, optical data storage devices, etc.

FIG. 19 is a block diagram of a device 400 for reporting power information according to one or more embodiments. For example, the device 400 can be provided as a server. As shown in FIG. 19, the device 400 includes a processing component 422, which further includes one or more processors, as well as memory resources represented by a memory 432, for storing instructions that can be executed by the processing component 422, such as application programs. The application programs stored in memory 432 may include one or more modules corresponding to a set of instructions. In addition, the processing component 422 is configured to execute instructions to implement the method described above.

The device 400 can further include a power component 426 configured to perform power management of the device 400, a wired or wireless network interface 450 configured to connect the device 400 to the network, and an input and output (I/O) interface 458. The device 400 can operate operating systems stored on the memory 432, such as Windows Server™, Mac OS X™, Unix™, Linux™, FreeBSD™, or similar systems.

In some embodiments, a non-transitory computer-readable storage medium including instructions is also provided, such as a memory 432 including instructions, which can be executed by a processor 422 of the device 400 to complete above methods. For example, the non-transitory computer-readable storage medium can be ROM, random access memory (RAM), CD-ROM, tapes, floppy disks, optical data storage devices, etc.

It should be further understood that “multiple” in the present disclosure refers to two or more, and other quantifiers are similar. “And/or” describes an association relationship between associated objects, indicating that there can be three relationships. For example, A and/or B can indicate that A alone, both A and B, or B alone. The character “/” generally indicates that the associated objects have an “or” relationship. The singular forms “one”, “a” and “the” are also intended to include majority forms, unless the context clearly indicates otherwise.

It should be further understood that the meanings of words such as “in response” and “if” involved in the present disclosure depend on the context and the actual usage scenario. For example, the word “in response” used here can be interpreted as “when”, “while”, “if”, or “in the case that”.

It should be further understood that the terms “first”, “second” and the like are used to describe various kinds of information, but such information should not be limited to these terms. These terms are only used to distinguish the same type of information from each other, and do not indicate a specific order or importance. In fact, the expressions “first” and “second” can be used interchangeably. For example, without departing from the scope of the present disclosure, the first information can also be referred to as the second information, and similarly, the second information can also be referred to as the first information.

It should be further understood that although the operations in embodiments of the present disclosure are described in a specific order in the drawings, they should not be understood that these operations are required to be performed in the specific order or serial order shown, or that all of the operations shown are required to be performed to achieve the desired results. Multitasking and parallel processing may be advantageous in a particular environment.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure.

It should be understood that the present disclosure is not limited to the precise structure described above and shown in the drawings, and various modifications and changes can be made without departing from its scope. The scope of the present disclosure is limited only by the appended claims.

1. A method for reporting power information, performed by a terminal, the method comprising:
determining power field enhancement information of one or more carriers/cells, wherein the power field enhancement information is based on Specific Absorption Rate (SAR) or Maximum Permissible Exposure (MPE) requirements, and comprises one or more of Power Headroom, Maximum Power Reduction, and transmit power information; and
reporting the power field enhancement information of the one or more carriers/cells to a network device.

2. The method according to claim 1, wherein the power field enhancement information comprises the transmit power information, and the transmit power information comprises at least one of:
a maximum transmit power;
a power class type;
a power class adjustment amount; or
a power class adjustment direction.

3. The method according to claim 2, wherein reporting the power field enhancement information of the one or more carriers/cells to the network device, comprises at least one of:
reporting the transmit power information corresponding to each carrier/cell in the one or more carriers/cells to the network device;
reporting transmit power information corresponding to a carrier/cell of which the transmit power information changes in the one or more carriers/cells to the network device; or
reporting the power class type corresponding to each carrier/cell in the one or more carriers/cells to the network device.

4. (canceled)

5. The method according to claim 3, wherein the transmit power information corresponding to the carrier/cell of which the transmit power information changes is comprised in an information indication field, and the information indication field is configured to indicate whether the transmit power information changes or not.

6. The method according to claim 5, wherein that the transmit power information changes comprises at least one of:
that the power class type changes; or
that the power class adjustment direction changes.

7. The method according to claim 6, wherein the information indication field comprises at least one of:
a first information indication field, in response to that the transmit power information changes comprises that the power class type changes, the first information indication field being configured to indicate whether the power class type changes or not; or
a second information indication field, in response to that the transmit power information changes comprises that the power class adjustment direction changes, the second information indication field being configured to indicate a power class adjustment direction of a carrier/cell of which the power class adjustment direction changes.

8. (canceled)

9. The method according to claim 7, wherein different code points in the second information indication field are configured to indicate different power class adjustment directions of the one or more carriers/cells.

10. (canceled)

11. The method according to claim 5, wherein the information indication field comprises a third information indication field, and the third information indication field is configured to indicate whether the power class type of each carrier/cell in the one or more carriers/cells is a default power class type, or different bit values of different bits in the third information indication field are configured to indicate the power class types of different carriers/cells.

12. (canceled)

13. The method according to claim 5, wherein the information indication field is comprised in at least one of the following signaling:
a newly defined Media Access Control-Control Element (MAC-CE) configured to comprise an Energy Headroom Report (EHR);
Radio Resource Control (RRC) signaling; or
Uplink Control Information (UCI).

14. The method according to claim 1, wherein the carriers/cells correspond to multiple frequency ranges, and the multiple frequency ranges comprise one of the following combinations:
a combination of a Frequency Range 1 (FR1) and FR1;
a combination of FR1 and a Frequency Range 2 (FR2); or
a combination of FR2 and FR2,
or wherein one of the carriers/cells is a carrier/cell in a single-carrier scenario, a carrier aggregation scenario, or a dual connection scenario, and multiple of the carriers/cells are carriers/cells in the carrier aggregation scenario or the dual connection scenario.

15. (canceled)

16. A method for reporting power information, performed by a network device, the method comprising:
receiving power field enhancement information of one or more carriers/cells sent by a terminal, wherein the power field enhancement information is based on Specific Absorption Rate (SAR) or Maximum Permissible Exposure (MPE) requirements, and comprises one or more of Power Headroom, Maximum Power Reduction, and transmit power information.

17. The method according to claim 16, wherein the power field enhancement information comprises the transmit power information, and the transmit power information comprises at least one of:
a maximum transmit power;
a power class type;
a power class adjustment amount; or
a power class adjustment direction.

18. The method according to claim 17, wherein receiving the power field enhancement information of the one or more carriers/cells sent by the terminal, comprises at least one of:
receiving the transmit power information corresponding to each carrier/cell in the one or more carriers/cells sent by the terminal, wherein the transmit power information is based on the SAR or the MPE requirements;
receiving transmit power information corresponding to a carrier/cell of which the transmit power information changes in the one or more carriers/cells sent by the terminal; or
receiving the power class type corresponding to each carrier/cell in the one or more carriers/cells sent by the terminal.

19. (canceled)

20. The method according to claim 18, wherein the transmit power information corresponding to the carrier/cell of which the transmit power information changes is comprised in an information indication field, the information indication field is configured to indicate whether the transmit power information changes or not, and that the transmit power information changes comprises at least one of: that the power class type changes; or that the power class adjustment direction changes.

21. (canceled)

22. The method according to claim 20, wherein the information indication field comprises at least one of:
a first information indication field, in response to that the transmit power information changes comprises that the power class type changes, the first information indication field being configured to indicate whether the power class type changes or not; or
a second information indication field, in response to that the transmit power information changes comprises that the power class adjustment direction changes, the second information indication field being configured to indicate a power class adjustment direction of a carrier/cell of which the power class adjustment direction changes, and different code points in the second information indication field being configured to indicate different power class adjustment directions of the one or more carriers/cells.

23-25. (canceled)

26. The method according to claim 20, wherein the information indication field comprises a third information indication field, and the third information indication field is configured to indicate whether the power class type of each carrier/cell in the one or more carriers/cells is a default power class type, or different bit values of different bits in the third information indication field are configured to indicate the power class types of different carriers/cells.

27. (canceled)

28. The method according to claim 20, wherein the information indication field is comprised in at least one of the following signaling:
a newly defined Media Access Control-Control Element (MAC-CE) configured to comprise an Energy Headroom Report (EHR);
Radio Resource Control (RRC) signaling; or
Uplink Control Information (UCI).

29. The method according to claim 16, wherein the carriers/cells correspond to multiple frequency ranges, and the multiple frequency ranges comprise one of the following combinations:
a combination of a Frequency Range 1 (FR1) and FR1;
a combination of FR1 and a Frequency Range 2 (FR2); or
a combination of FR2 and FR2,
or wherein one of the carriers/cells is a carrier/cell in a single-carrier scenario, a carrier aggregation scenario, or a dual connection scenario, and multiple of the carriers/cells are carriers/cells in the carrier aggregation scenario or the dual connection scenario.

30-32. (canceled)

33. A device for reporting power information, comprising:
a processor; and
a memory configured to store executable instructions for the processor,
wherein the processor is configured to perform the method for reporting power information according to claim 1.

34. A device for reporting power information, comprising:
a processor; and
a memory configured to store executable instructions for the processor,
wherein the processor is configured to perform the method for reporting power information according to claim 16.

35-36. (canceled)
